(19) United States
(12) Patent Application Publication
(10) Pub. No.: US 2014/0209709 A1
(43) Pub. Date: Jul. 31, 2014

(54) NOZZLE

(71) Applicant: EAGLE ACTUATOR COMPONENTS GMBH & CO. KG, Weinheim (DE)

(72) Inventor: Joerg BITTNER, Laudenbach (DE)

(21) Appl. No.: 14/168,419

(22) Filed: Jan. 30, 2014

(30) Foreign Application Priority Data
Jan. 30, 2013 (DE) 10 2013 001 550.2
Jan. 31, 2013 (DE) 10 2013 001 549.9

(51) Int. Cl. B05B 1/02

(52) U.S. Cl. CPC B05B 1/02
USPC 239/589

(57) ABSTRACT

A nozzle, comprising a nozzle body having a flow cross sectional area through which a fluid can be led, with a view to solving the problem of producing a nozzle by means of which power losses can be reduced, is characterized in that the size of the flow cross sectional area is settable by a control body.

### CROSS REFERENCE TO RELATED APPLICATIONS

This application claims priority to German Patent Application No. 10 2013 001 550.2 filed on Jan. 30, 2013 and German Patent Application No. 10 2013 001 549.9 filed on Jan. 31, 2013, the disclosures of which are incorporated by reference herein in their entirety.

### FIELD OF THE INVENTION

The invention relates to a nozzle comprising a nozzle body having a flow cross sectional area through which a fluid can be led, characterized in that the size of the flow cross sectional area is settable by a control body.

### BACKGROUND

Nozzles of this kind in which a fluid can flow through a defined flow cross sectional area are already known.

The fluid can flow through the nozzle and leave said nozzle through a certain flow cross sectional area.

In view of this background, there is a need for a discharge element which is used in a cleaning system of a motor vehicle and which is suitable for cleaning an activated charcoal filter even during a charging mode of a motor. The goal is to prevent power losses, particularly at high charge states.

The invention is therefore based on the problem of producing a nozzle by means of which power losses can be reduced.

### SUMMARY

According to the invention, it has been recognized that a nozzle can be switched by means of a control body to at least two positions each of which is associated with a concrete throughput. By setting the size of a certain flow cross sectional area through which a fluid can flow, the nozzle can be adapted to the given performance conditions.

Consequently, the mentioned problem is solved.

The size could be settable stepwise, namely by discrete distances. It is preferable for the size to be settable between two values. In this manner, the nozzle can be switched rapidly and reliably.

The size could be continuously settable. As a result, many sizes and thus many fluid throughputs are selectable. In this manner, the nozzle can be adapted to numerous charge states.

The flow cross sectional area could be completely closable by the control body. In this manner, the nozzle can be used as a valve which interrupts a fluid flow.

The control body could be formed as a rod. A blunt rod having a rectangular cross section is easy to produce.

The control body could be formed as a tube having a passage. As a result, the size of an annular gap can be changed, wherein the cross sectional area of the throughput is always connected in parallel with the annular gap. The outer dimensions of the tube could narrow so as to be insertable with no problem into a narrowed site of the nozzle body. The passage could also narrow.

The control body could be formed as a plug having a central passage, which can close an annular gap by application onto an inner tube within the nozzle body. This concrete embodiment ensures that the inner tube and the nozzle body in the axial direction always define the same annular gap sizes.

The control body could be movable within the nozzle body relative to the said body. In this manner, the flow cross sectional area can be changed without moving the nozzle body. It is also conceivable for the control body to be stationary and for the nozzle body to be moved. In this manner, a compact nozzle that saves installation space can be produced.

The control body or the nozzle body could be movable by an electromagnetic device. As a result, the nozzle is rapidly switchable.

The control body or the nozzle body could be movable pneumatically by using pressure differences. Thus, the pressure conditions within a turbocharger could be used advantageously.

The nozzle is preferably configured as a Venturi nozzle.

Further advantages and features of the invention result from the following description of several embodiment examples in reference to the drawing.

### BRIEF DESCRIPTION OF THE DRAWING

FIG. 1 shows a nozzle according to the invention in cross section, wherein the control body is designed as a rod having a parallelepiped cross section, wherein the control body in the top view is in a first position and wherein the control body in the bottom view is in a second position;

FIG. 2 shows another nozzle according to the invention in cross section, wherein the control body is configured as a tube that narrows in cross section, which comprises a passage having a narrowing cross section, wherein the control body in the top view is in a first position and wherein the control body in the bottom view is in a second position;

FIG. 3 shows another nozzle according to the invention having a compact design in cross section, wherein the control body is configured as a tube which narrows in cross section, and which comprises a passage having a narrowing cross section, wherein the nozzle body in the top view is in a first position and wherein the nozzle body in the bottom view is in a second position;

FIG. 4 shows another nozzle according to the invention in cross section, wherein the control body is configured as a plug having a central passage, wherein the control body in the top view is in a first position and wherein the control body in the bottom view is in a second position; and

FIG. 5 shows another nozzle according to the invention, which shows the structure according to FIG. 4, wherein, however, passage openings for a fluid are provided in the inner tube.

### DETAILED DESCRIPTION

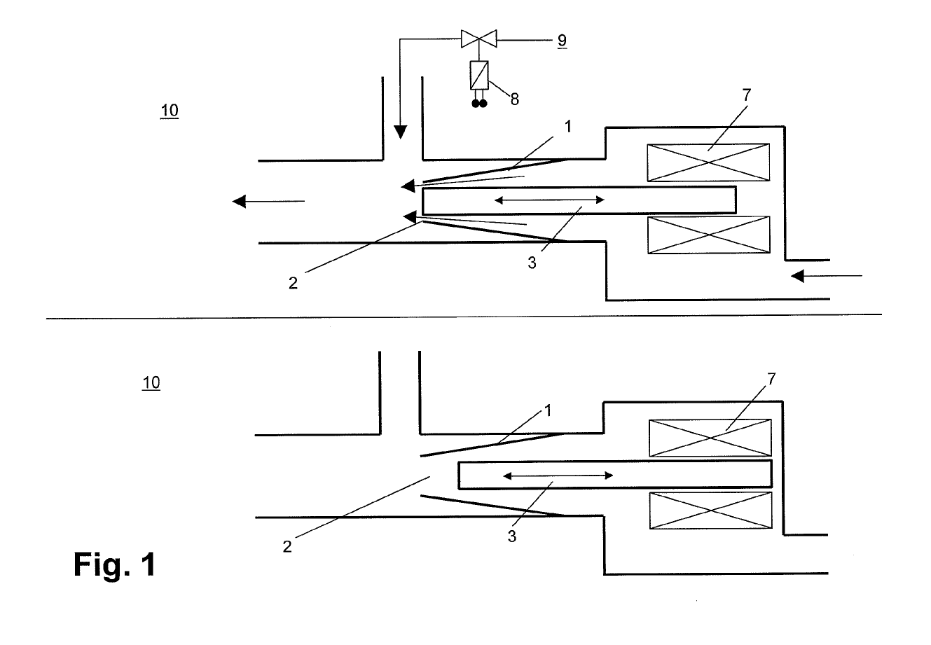

FIG. 1 shows a nozzle comprising a nozzle body 1 having at least one flow cross sectional area 2 through which a fluid can be led. The size of the flow cross sectional area 2 is settable by a control body 3. The size is settable stepwise, by discrete distances. It is preferable to be able to select between two sizes.

The flow cross sectional area 2 can be closed completely by the control body 3. The control body 3 is configured as a rod.

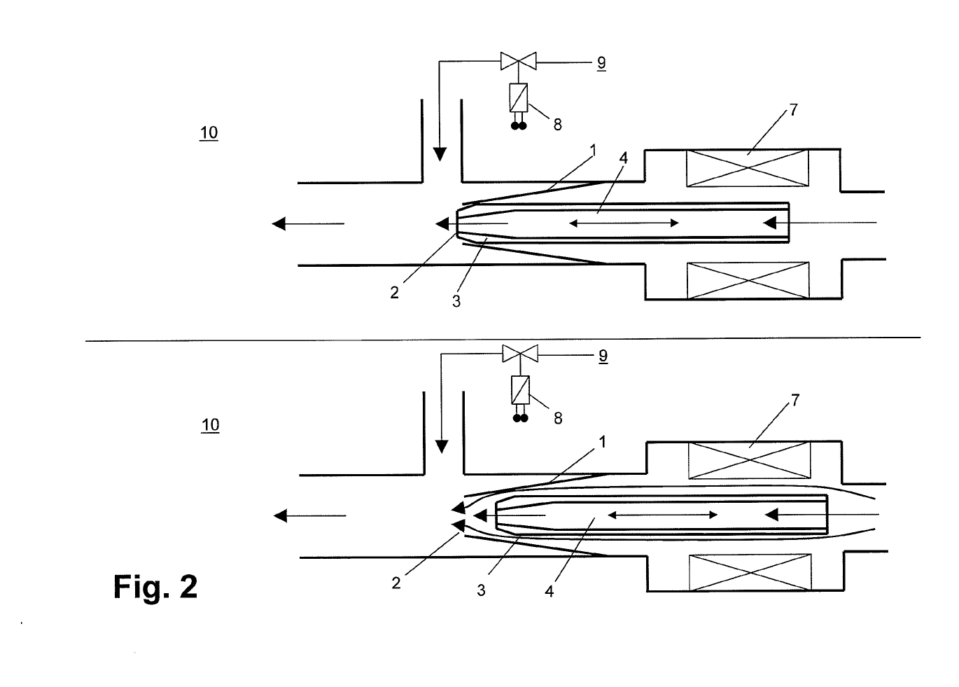

FIG. 2 shows a nozzle, in which the control body 3 is configured as a tube having a passage 4. The size of the flow cross sectional area 2 is settable continuously.

In the nozzles of FIGS. 1 and 2, the control body 3 is movable within the nozzle body 1 relative to the latter. The control body 3 is movable by an electromagnetic device 7. The control body 3 could also be movable pneumatically by using pressure differences.

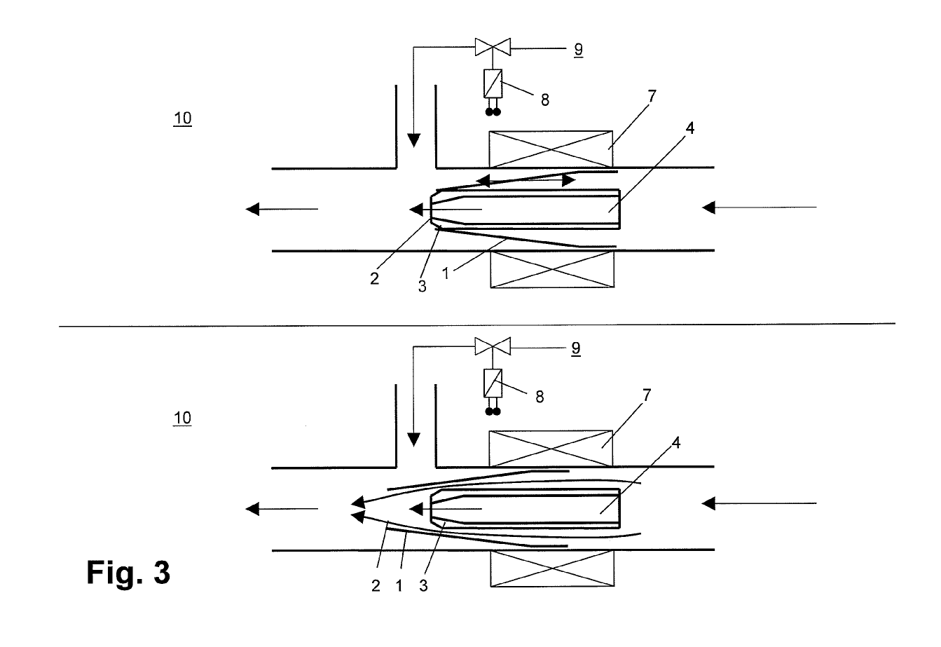

FIG. 3 shows a nozzle in which the control body 3 is configured as a tube having a passage 4. The nozzle body 1 is movable relative to a stationary control body 3. As a result, the electromagnetic device 7 can have a design that is relatively short. The nozzle body 1 is movable by an electromagnetic device 7. The nozzle body 1 could also be movable pneumatically by using pressure differences.

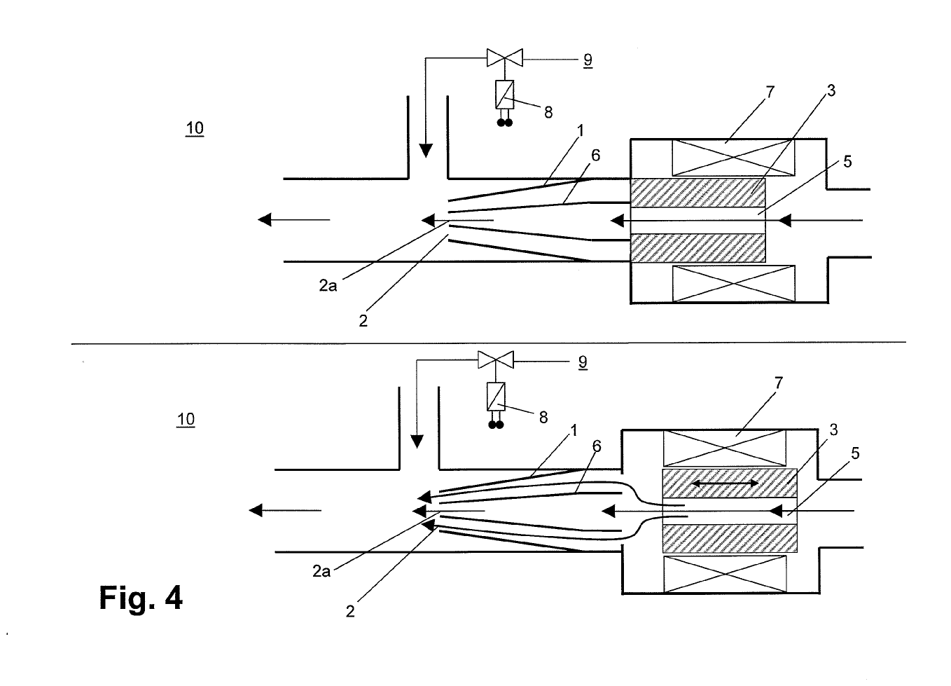

FIG. 4 shows a nozzle in which the control body 3 is designed as a plug having a central passage 5. The plug can close an annular gap by application onto an inner tube 6 which is arranged within the nozzle body 1. However, an opening 2a remains flow connected to the central passage 5.

Since the nozzle body 1 and the inner tube 6 are stationary, they can define a very precise annular gap without play. In addition, the installation space for the nozzle can be made smaller. Moreover, this plug allows a very precise external closure of the inner tube 6.

The control body 3 is movable by an electromagnetic device 7. The control body 3 could also be pneumatically movable by using pressure differences.

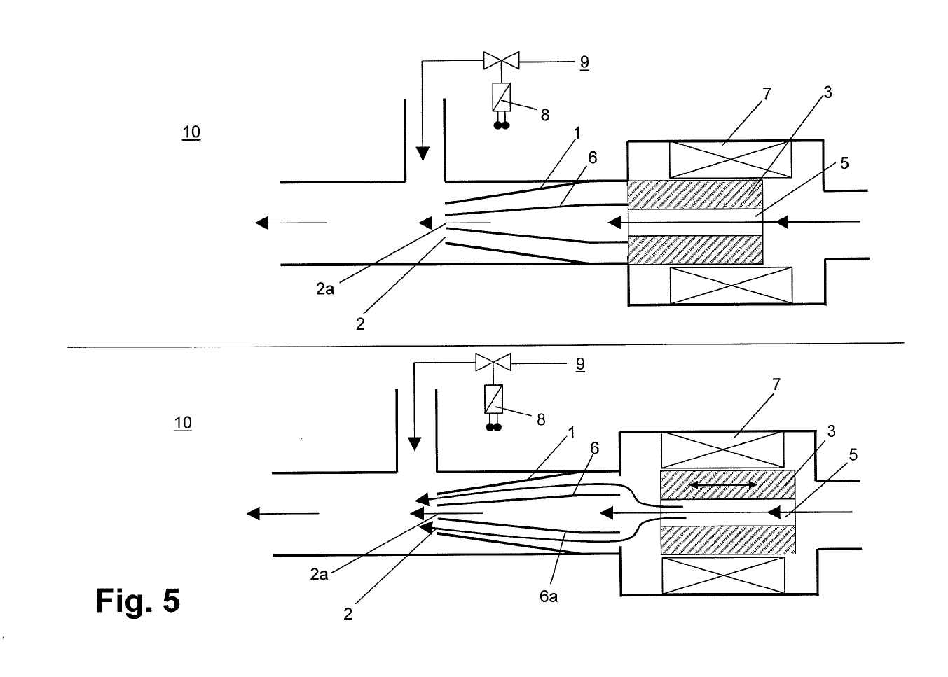

FIG. 5 shows a nozzle in which the control body 3 is designed as a plug having a central passage 5. The plug can close an annular gap by application onto an inner tube 6 which is arranged within the nozzle body 1. However, an opening 2a remains flow connected to the central passage 5. A fluid can flow through the central passage 5 into the inner tube 6. In the inner tube 6 one or more passage openings 6a are provided, through which a fluid can flow into the space between nozzle body 1 and inner tube 6.

Since the nozzle body 1 and the inner tube 6 are stationary, they can define a very precise annular gap without play. In addition, the installation space for the nozzle can be made smaller. Moreover, by means of the plug, a very precise external closure of the inner tube 6 is possible.

The control body 3 is movable by an electromagnetic device 7. The control body 3 could also be pneumatically movable by using pressure differences.

The electromagnetic device 7 comprises a coil. The control body 3 or the nozzle body 1 comprises metals so as to be movable by the magnetic field of the electromagnetic device 7. In FIGS. 1 to 4, a regeneration valve 8 provides a flow connection to an activated charcoal filter 9. The reference numeral 10 designates the atmosphere side of a turbocharger. The nozzle is configured as a switchable Venturi nozzle.

What is claimed is:

1. A nozzle comprising a nozzle body having a flow cross sectional area through which a fluid can be led, wherein the size of the flow cross sectional area is settable by a control body.

2. The nozzle according to claim 1, wherein the size is settable stepwise, namely by discrete distances.

3. The nozzle according to claim 1, wherein the size is settable continuously.

4. The nozzle according to claim 1, wherein the flow cross sectional area is completely closable by the control body.

5. The nozzle according to claim 1, wherein the control body is configured as a rod.

6. The nozzle according to claim 1, wherein the control body is configured as a tube having a passage.

7. The nozzle according to claim 1, wherein the control body is configured as a plug having a central passage, which can close an annular gap by application onto an inner tube within the nozzle body.

8. The nozzle according to claim 1, wherein the control body is movable within the nozzle body relative to the latter.

9. The nozzle according to claim 1, wherein the control body or the nozzle body is movable by an electromagnetic device.

10. The nozzle according to claim 1, wherein the control body or the nozzle body is movable pneumatically by using pressure differences.
